(19) United States
(12) Patent Application Publication
(10) Pub. No.: US 2010/0238118 A1
(43) Pub. Date: Sep. 23, 2010

(54) SYSTEM AND METHOD FOR PROVIDING TEXT INPUT TO A COMMUNICATION DEVICE

(75) Inventor: Torgny HEIMLER, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/408,065

(22) Filed: Mar. 20, 2009

(51) Int. Cl. G06F 3/02

(52) U.S. Cl. 345/169

(57) ABSTRACT

A system and method for generating symbols in a mobile communication device is provided. The system may be provided with a chart provided with symbols, such as Hindi characters, and a device for retrieving information related to the presented symbols, the read retrieved information may then be processed and used for identifying the selected symbol in a symbol database and the symbol may then be presented on a display within the mobile communication device.

### TECHNICAL FIELD

The present invention relates to inputting text to a communication device.

### BACKGROUND ART

Today, there exist many types of electronic devices such as mobile devices, media players, palmtop computers etc. Mobile devices such as mobile phones, for example, are normally equipped with a communications protocol forming part of the GSM system and allowing transmission of text messages between such mobile phones.

According to known technology, text messages, such as SMS, email, Instant messaging can be composed and entered by the user into the mobile phone e.g. by using the keypad of the phone. More precisely, characters such as letters, digits and other symbols are entered into the phone manually by pressing the corresponding keys on the keypad.

Text input in so-called Abugida languages, such as several African, South and South-East Asian languages, e.g. Hindi, is much harder than for Latin based languages due to language structure and sheer number of letters and ligatures. It is difficult with a small number of keys on a typical keyboard found on most mobile phones.

Existing systems and methods typically rely on multiple depressions of a certain key to scroll through a limited set of letters, usually those displayed on the key, and to select a particular letter for entry when the key depression terminates. While well suited for use with those languages that employ the Latin alphabet, this conventional technique can prove to be limiting when attempting to enter other types of alphabetic symbols associated with another languages, which can have more complex rules relating to relationships between constituent parts of the written languages, such as vowels, semi-vowels, consonants and special characters and modifiers. Hindi is one such language.

As such, to enter a language such as Hindi a significant problem arises when one desires to employ a device capable of text entry, such as a mobile phone, that is provided with a simple 12 key numeric-type of keypad. The user sometimes may have to multitap up to 12 times to input common letters, which makes text input slow and error prone. There is also a problem when two or more letters or symbols have to be combined to create the correct message.

### SUMMARY OF THE INVENTION

With the above description in mind, then, an aspect of some embodiments of the present invention is to provide an improved system and method for entering Abugida languages, such as Hindi, text into an electronic device, which seeks to mitigate, alleviate or eliminate one or more of the above-identified deficiencies in the art and disadvantages singly or in any combination.

An aspect of the present invention relates to a system for generating symbols in a mobile communication device. The system may comprise a presentation element for presenting at least one symbol, means for retrieving information related to the presented symbols, means for processing the read retrieved information and identifying the related symbol in a symbol database and means for displaying the identified symbol on a display unit within the mobile communication device.

In one embodiment the system may further comprise means for combining at least two identified symbols and displaying the combination on the display unit.

In one embodiment the presentation element may comprise at least a first chart with at least one printed symbol and at least one identification means corresponding to said printed symbol.

In one embodiment, the presentation element may comprise a first chart with at least one printed symbol and at least one RFID circuit corresponding to the printed symbol. Additionally, the presentation element may comprise a first chart with at least one printed symbol and a second chart with at least one RFID circuit corresponding to the printed symbols. Further on, the means for retrieving information may comprise means for receiving identification information from the at least one RFID circuit corresponding to the printed symbol.

In one embodiment, the presentation element may comprise a first chart comprising at least one printed symbol and at least one reflective pattern corresponding to the printed symbol. Additionally, the presentation element may comprise a first chart comprising at least one printed symbol and a second chart comprising at least one reflective pattern corresponding to the printed symbol. Further on, the means for retrieving information may comprise an optical circuit adapted for receiving identification information from the at least one reflective pattern corresponding to at least one symbol.

In one embodiment, a third chart, comprising a second set of printed symbols, may be applied on top of the first chart.

In one embodiment, the presentation element may comprise a first chart with at least one printed symbol and at least one sound generating pattern corresponding to the printed symbols. Further on the means for retrieving information may comprise means for recording said generated sound.

In one embodiment, the presentation element may comprise means for visually projecting an image comprising at least one symbol on a surface. Further on the system may comprise means for selecting a projected symbol, and wherein the means for retrieving information comprises an optical circuit adapted for collecting identification information related to the at least one selected projected symbol.

Another aspect of the present invention relates to a method for symbol input into a mobile communication device. The method may comprise the steps of choosing a symbol database, presenting a presentation element with symbols from the chosen symbol database, selecting at least a first symbol from the presentation element, retrieving identification information related to the selected symbol, processing the retrieved identification information and identifying the selected symbol in the selected symbol database and displaying the at least one identified symbol on a display unit.

In one embodiment, the step of selecting may further comprise selecting at least a first and a second symbol from the presentation element, the retrieving step may further comprise retrieving identification information related to the at least first and second selected symbol and the processing step may further comprise processing and identifying the at least first and second selected symbols. The method may further comprise the step of combining the at least first and second identified symbols and presenting the at least one combination on a display.

In one embodiment, the selecting step may further comprise generating a sound corresponding to the at least one symbol from the presentation element and the retrieving step may further comprise recording the generated sound.

The features of the above-mentioned embodiments can be combined in any combinations.

It is an advantage with some embodiments of the invention that they provide for an easy and intuitive way of using an electronic device for entering Abugida languages, such as Hindi, text into such a device.

### BRIEF DESCRIPTION OF THE DRAWINGS

Further objects, features and advantages of the present invention will appear from the following detailed description of the invention, wherein embodiments of the invention will be described in more detail with reference to the accompanying drawings, in which:

FIG. 1 shows a schematic view of a system comprising a mobile phone communicating with a presentation device according to one embodiment of the present invention;

FIG. 2 shows a schematic block diagram of a system of the above-mentioned type;

FIG. 3 shows a schematic view of a system according to one embodiment of the present invention;

FIG. 4 shows a schematic view of a system according to one embodiment of the present invention;

FIG. 5 shows a schematic view of a system according to one embodiment of the present invention;

FIG. 6 shows a schematic view of a system according to one embodiment of the present invention.

### DETAILED DESCRIPTION

Embodiments of the present invention relate, in general, to the field of mobile terminals. One embodiment relates to a portable communication device, such as a mobile phone, including one or more text input devices. However, although the invention is particularly suitable for mobile phones, it is as such equally applicable to other electronic devices (which may include radio communication capabilities) and the shape of the text inputting device may be of any shape. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

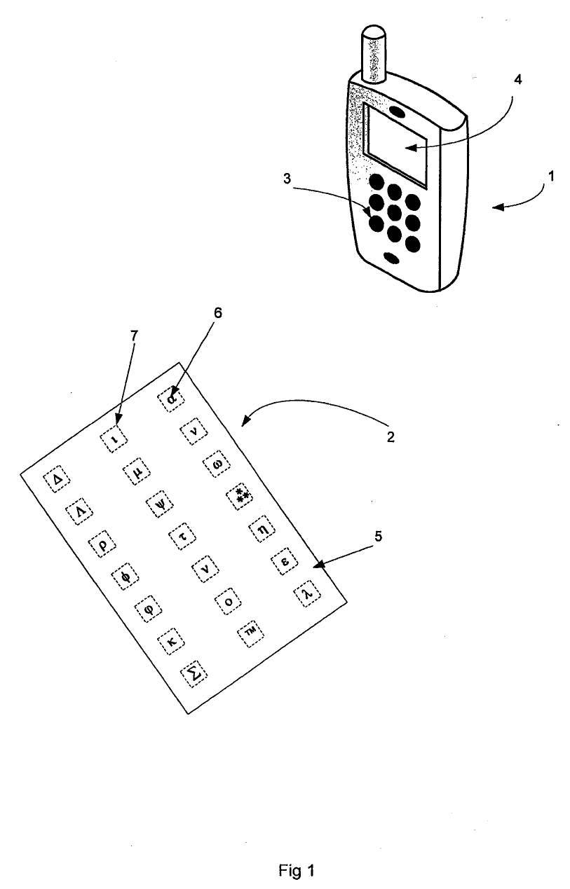

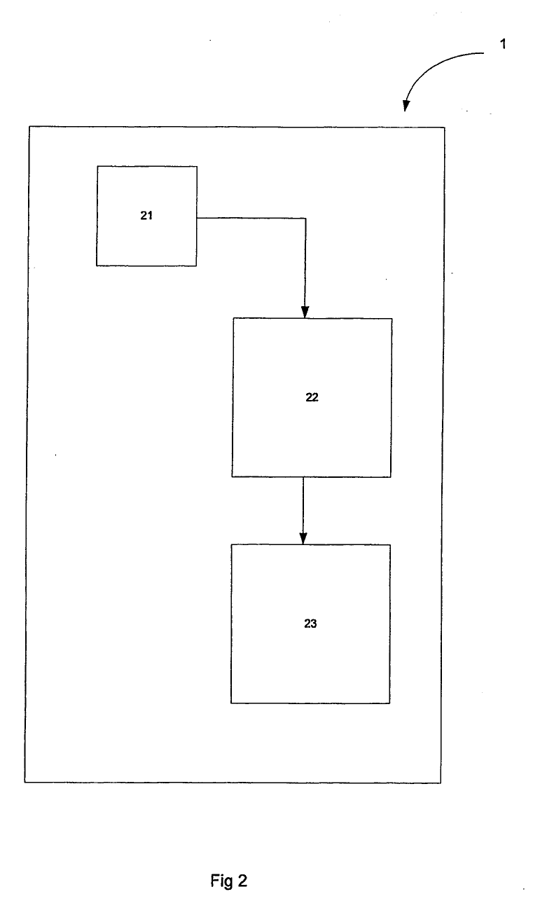

With reference to FIG. 1, there is shown a schematic view of a system comprising a mobile phone 1 and a symbol presentation device 2. Further the system comprises, as shown in FIG. 2, a symbol retrieving unit 21, a processing unit 22, and a display unit 23 for generating symbols and presenting them on a display 4 of the mobile phone. The retrieving unit, processing unit and display unit may be incorporated in the mobile phone but the may also be separate units positioned outside the mobile phone. The symbol presentation device 2 according to the invention may equally well be used, for example, together with another communication device in the form of a palmtop computer, a Smartphone, a pager and similar devices.

In a conventional manner, the mobile phone 1 is provided with a keypad 3 and a display 4. As indicated schematically in FIG. 1, the communication between the mobile phone 1 and the presentation device 2 is wireless, by means of different input technologies.

The symbol retrieving unit 21 is adapted for retrieving information related to the symbols 6 presented on the presentation device 2, which will be described further.

The processing unit 22 is adapted for processing the retrieved information and identifying the symbols in a symbol database. The symbol database may be installed in the mobile phone 1 or on a separate server, which communicates with the mobile phone 1.

The display unit 4 is adapted for presenting the processed and identified symbol, modifiers and possible ligatures. The processing unit 22 further comprises means for combining at least two identified symbols. The user may then select which combination is the correct combination.

The symbol presentation device 2 may comprise at least one chart 5 with printed symbols 6, such as Hindi symbols, and corresponding identification means 7. The presentation device may also comprise two charts, separated or assembled. The first chart includes the printed symbols 6 and the second chart includes the corresponding identification means. Each symbol on the chart has a corresponding identification means which provides information in different ways which are unique for the corresponding symbol. The first chart may be changed depending on what set of symbols the user would like to use or a third chart may be placed on top of the first chart with a different set of symbols.

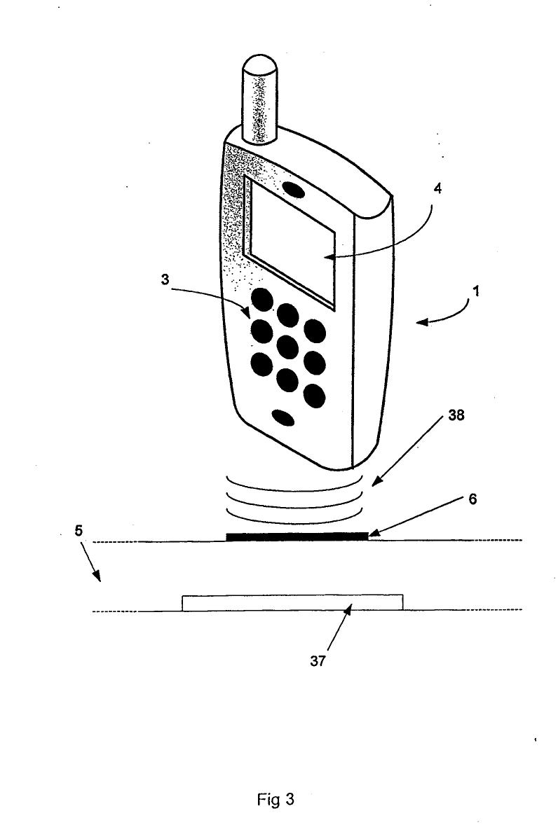

In one embodiment, as shown in FIG. 3, the identification means 7 comprises RFID circuits, which may be active or passive RFID tags. An active RFID tag has its own power source and act as a sender on it own. A passive RFID tag has no own power source and acts as a sender in response to induced power from another source. If the RFID tag is active the retrieving unit 21 is configured for receiving identification information 38 from the RFID tag. If the RFID tag is passive the retrieving unit is configured for sending a signal to the RFID tag for inducing power to the RFID tag and then the retrieving unit 21 is receiving the identification information 38 from the RFID tag.

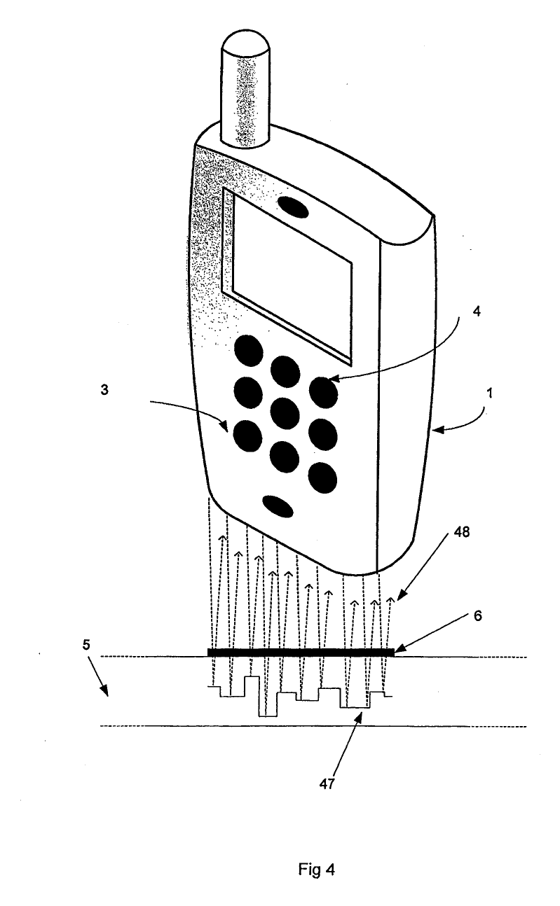

In one embodiment, as shown in FIG. 4, the identification means 7 comprises a pattern 47 incorporated in the chart 5. Each symbol on the chart 5 has at least one corresponding pattern 47. The pattern is reflective to optical radiation 48, such as IR. Since each symbol 6 on the chart 5 has at least one corresponding pattern 47 a unique optical signal is created for each of the corresponding symbol 6. The retrieving unit 21 comprises an optical circuit configured for sending optical radiation and collecting the unique optical signal.

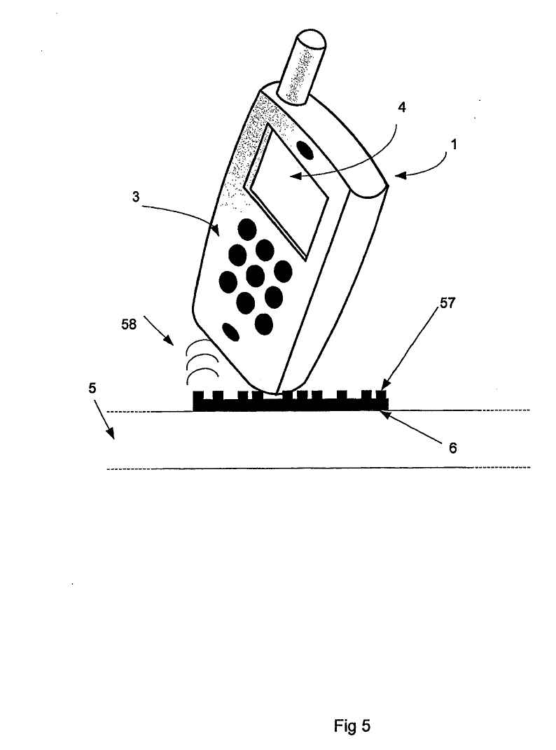

In one embodiment, as shown in FIG. 5, the presentation device 2 comprises a sound generating pattern 57 applied on the chart 5, wherein each pattern corresponds to at least one printed symbol 6. The retrieving unit 21 comprises a sound recording unit, not shown, such as a microphone, configured for recoding the sound 58 generated by touching or scratching the mobile phone or another object against the sound generated pattern 57.

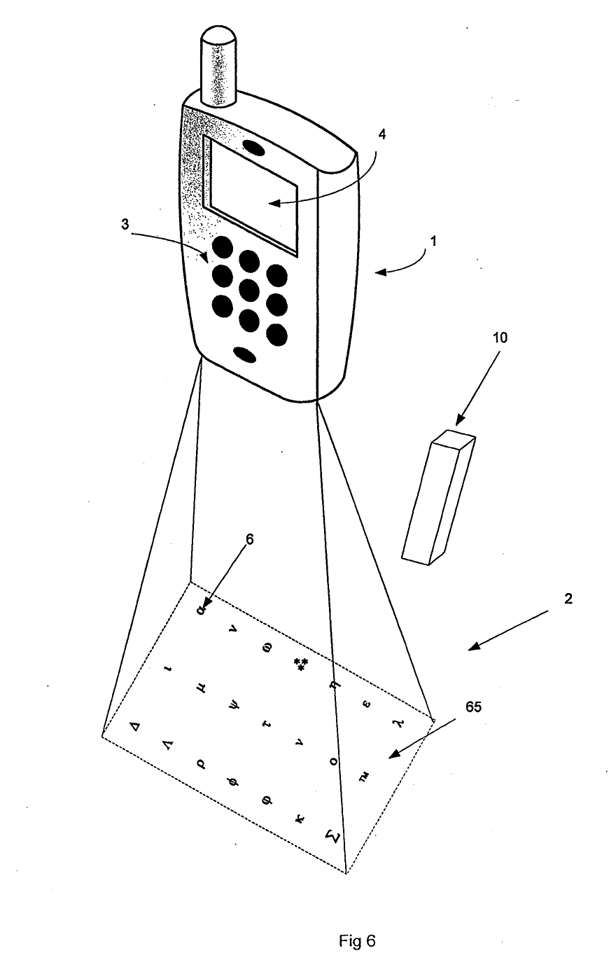

In one embodiment, as shown in FIG. 6, the presentation device 2 further comprises a projecting unit, not shown, which may be incorporated in the mobile phone 1, for projecting an image of a chart 65 comprising at least one symbol 6 on a surface. The system further comprises means for selecting 10 a projected symbol 6. The selecting means 10 may be a pen, a finger or some kind of pointing device. The retrieving unit 21 further comprises an optical circuit configured for retrieving the selected projected symbol 6.

In one embodiment, the identification means 7 comprises a bar code pattern applied on the chart 5. Each symbol on the chart 5 has at least one corresponding bar code pattern. The retrieving unit 21 comprises a bar code reader configured for reading the bar code and retrieving the identification information corresponding to the selected symbol.

In one embodiment, the identification means 7 comprises an OCR pattern applied on the chart 5. Each symbol on the chart 5 has at least one corresponding OCR pattern. The retrieving unit 21 comprises a camera unit configured for collecting the OCR pattern and retrieving the identification information corresponding to the selected symbol.

In one embodiment, a method for inputting symbols in a mobile phone may comprise the steps of selecting a symbol on a chart by the user, tapping the mobile phone on the selected symbol then initiate the retrieving unit to retrieve identification information presented on the chart in form of a RFID circuit, bar code, sound generating pattern, optical pattern, as presented. The retrieved identification information may then be processed in the mobile phone, or in a device placed outside the mobile phone. The processed information is used for identifying a symbol in a symbol database which corresponds to the selected symbol. The identified symbol is then presented on the display on the mobile phone.

The invention may be implemented by suitable combinations of software and hardware as is known in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A system for generating symbols in a mobile communication device, said system comprising:
a presentation element for presenting at least one symbol;
means for retrieving information related to said presented symbols;
means for processing said read retrieved information and identifying said related symbol in a symbol database; and
means for displaying said identified symbol on a display unit within said mobile communication device.

2. The system according to claim 1, further comprising means for combining at least two identified symbols and displaying said combination on said display unit.

3. The system according to claim 1, wherein said presentation element comprising:
at least a first chart with at least one printed symbol and at least one identification means corresponding to said printed symbol.

4. The system according to claim 1, wherein said presentation element comprising:
a first chart with at least one printed symbol and at least one RFID circuit corresponding to said printed symbol.

5. The system according to claim 1, wherein said presentation element comprising:
a first chart with at least one printed symbol; and
a second chart with at least one RFID circuit corresponding to said printed symbols.

6. The system according to claim 4, wherein said means for retrieving information comprises means for receiving identification information from said at least one RFID circuit corresponding to said printed symbol

7. The system according to claim 1, wherein said presentation element comprising:
a first chart comprising at least one printed symbol and at least one reflective pattern corresponding to said printed symbol.

8. The system according to claim 1, wherein said presentation element comprising:
a first chart comprising at least one printed symbol; and
a second chart comprising at least one reflective pattern corresponding to said printed symbol.

9. The system according to claim 7, wherein said means for retrieving information comprises an optical circuit adapted for receiving identification information from said at least one reflective pattern corresponding to at least one symbol.

10. The system according to claim 3, wherein a third chart comprising a second set of printed symbols may be applied on top of said first chart.

11. The system according to claim 1, wherein said presentation element comprising:
a first chart with at least one printed symbol and at least one sound generating pattern corresponding to said printed symbols.

12. The system according to claim 11, wherein said means for retrieving information comprises means for recording said generated sound.

13. The system according to claim 1, wherein said presentation element comprising:
means for visually projecting an image comprising at least one symbol on a surface.

14. The system according to claim 13, wherein said system further comprising means for selecting a projected symbol, and wherein said means for retrieving information comprises an optical circuit adapted for collecting identification information related to said at least one selected projected symbol.

15. A method for generating symbols in an mobile communication device comprising the steps of:
choosing a symbol database;
presenting a presentation element with symbols from said chosen symbol database;
selecting at least a first symbol from said presentation element;
retrieving identification information related to said selected symbol;
processing said retrieved identification information and identifying said selected symbol in said selected symbol database; and
displaying said at least one identified symbol on a display unit.

16. The method according to claim 15, wherein said step of selecting further comprising selecting at least a first and a second symbol from said presentation element;
said retrieving step further comprising retrieving identification information related to said at least first and second selected symbol,
said processing step further comprising processing and identifying said at least first and second selected symbols; and
said method further comprising the step of:
combining said at least first and second identified symbols; and
presenting said at least one combination on a display.

17. The method according to claim 15, wherein said selecting step further comprising generating a sound corresponding to said at least one symbol from said presentation element and said retrieving step further comprising recording said generated sound.
